(19) United States
(12) Patent Application Publication
(10) Pub. No.: US 2025/0023708 A1
(43) Pub. Date: Jan. 16, 2025

(54) ELECTRONIC DEVICE WITH HOMOMORPHIC ENCRYPTION

(71) Applicants: Samsung Electronics Co., Ltd., Suwon-si (KR); Graz University of Technology, Graz (AT)

(72) Inventors: Aikata AIKATA, Graz (AT); Ahmet Can MERT, Graz (AT); Sujoy SINHA ROY, Graz (AT); Sunmin KWON, Suwon-si (KR); Maksim DERIABIN, Suwon-si (KR)

(73) Assignees: Samsung Electronics Co., Ltd., Suwon-si (KR); Graz University of Technology, Graz (AT)

(21) Appl. No.: 18/770,439

(22) Filed: Jul. 11, 2024

(30) Foreign Application Priority Data
Jul. 11, 2023 (KR) 10-2023-0089995
Feb. 29, 2024 (KR) 10-2024-0029978

(51) Int. Cl. H04L 9/00; H01L 23/498; H01L 25/16; H04L 9/30

(52) U.S. Cl. CPC H04L 9/008; H01L 23/49816; H01L 25/16; H04L 9/3093; H04L 2209/125

(57) ABSTRACT

An electronic device includes a substrate, an interposer attached to a top of the substrate and comprising a plurality of through-silicon vias (TSVs), a plurality of core chiplets attached to a top of the interposer, and a plurality of memory chiplets attached to the top of the interposer, wherein each of the plurality of core chiplets comprises a number-theoretic transform (NTT) module.

### CROSS-REFERENCE TO RELATED APPLICATIONS

This application claims the benefit under 35 USC § 119(a) of Korean Patent Application No. 10-2023-0089995, filed on Jul. 11, 2023, and Korean Patent Application No. 10-2024-0029978, filed on Feb. 29, 2024, in the Korean Intellectual Property Office, the entire disclosures of which are incorporated by reference herein for all purposes.

### BACKGROUND

### 1. Field

The following description relates to an electronic device with homomorphic encryption (HE).

### 2. Description of Related Art

Homomorphic encryption (HE) is an encryption method that enables arbitrary operations between encrypted data. Utilizing HE enables arbitrary operations on encrypted data without decrypting the encrypted data, and HE is lattice-based and thus resistant to quantum algorithms and safe.

Chip sizes like those of central processing units (CPUs), graphics processing units (GPUs), and neural processing units (NPUs) may be large, e.g., may surpass 800 square millimeters (mm²) in size. This large size may lead to issues with increasing yield limitations in micro-processing technology. Implementing HE accelerators using application-specific integrated circuits (ASICs) may also increase the number of operators to enhance performance. This may lead to an increase in chip size, resulting in decreased yield.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an electronic device includes a substrate, an interposer attached to a top of the substrate and comprising a plurality of through-silicon vias (TSVs), a plurality of core chiplets attached to a top of the interposer, and a plurality of memory chiplets attached to the top of the interposer, wherein each of the plurality of core chiplets comprises a number-theoretic transform (NTT) module.

The plurality of memory chiplets may not be connected to each other.

The plurality of core chiplets may be electrically connected to each other in a ring structure through the interposer.

Each of the plurality of core chiplets may be configured to transmit data from the NTT module of a corresponding core chiplet to a core chiplet adjacent to the corresponding core chiplet in a first direction.

The NTT module may be configured to perform a homomorphic encryption (HE) operation comprising a relinearization operation, and the data from the NTT module may include inverse NTT (INTT) residue polynomial data generated from the relinearization operation.

Each of the plurality of core chiplets further may include a pair of multiply-accumulate (MAC) modules connected to the NTT module, and a pair of automorphism modules connected respectively to the pair of MAC modules.

Each of the plurality of core chiplets further may include a controller configured to obtain an operation completion signal from the NTT module, the pair of MAC modules, and the pair of automorphism modules, and control the NTT module and the pair of MAC modules to operate in parallel.

Each of the plurality of core chiplets further may include a first memory connected to the NTT module and configured to store an inverse NTT (INTT) operation result.

Each of the plurality of core chiplets may be configured to transmit the INTT operation result stored in the first memory of a corresponding core chiplet to a core chiplet adjacent to the corresponding core chiplet in a first direction.

The plurality of memory chiplets may include a high bandwidth memory (HBM) chiplet.

In one or more general aspects, an electronic device includes a substrate, an interposer attached to a top of the substrate and comprising a plurality of through-silicon vias (TSVs), a plurality of core chiplets attached to a top of the interposer, and a plurality of memory chiplets vertically attached to the plurality of core chiplets through a TSV, wherein each of the plurality of core chiplets may include a number-theoretic transform (NTT) module.

The plurality of core chiplets may be electrically connected to each other in a ring structure through the interposer.

Each of the plurality of core chiplets may be configured to transmit data from the NTT module of a corresponding core chiplet to a core chiplet adjacent to the corresponding core chiplet in a first direction.

Each of the plurality of core chiplets further may include a pair of multiply-accumulate (MAC) modules connected to the NTT module, and a pair of automorphism modules connected respectively to the pair of MAC modules.

The plurality of memory chiplets may include at least one of a high bandwidth memory (HBM) chiplet and a low-power double data rate (LPDDR) chiplet.

In one or more general aspect, an electronic device includes a number-theoretic transform (NTT) module, a pair of multiply-accumulate (MAC) modules connected to the NTT module, and a pair of automorphism modules connected respectively to the pair of MAC modules.

The electronic may include a controller configured to obtain an operation completion signal from the NTT module, the pair of MAC modules, and the pair of automorphism modules and control the NTT module and the pair of MAC modules to operate in parallel.

In one or more general aspects, an electronic device includes a substrate, an interposer attached to a top of the substrate and comprising a plurality of through-silicon vias (TSVs), a plurality of core chiplets attached to a top of the interposer, and a plurality of memory chiplets connected to the plurality of core chiplets through either the interposer or a TSV, wherein each of the plurality of core chiplets may include a number-theoretic transform (NTT) module.

The plurality of memory chiplets may be attached to the top of the interposer and horizontally spaced apart from the plurality of core chiplets.

The plurality of memory chiplets may be vertically attached to the plurality of core chiplets through the TSV.

Other features and aspects will be apparent from the following detailed description, the drawings, and the claims.

### BRIEF DESCRIPTION OF THE DRAWINGS

FIG. 1 illustrates an example of a homomorphic encryption (HE) system.

FIG. 2 illustrates an example of a 2.5 dimensional (2.5D) chiplet-based accelerator.

FIG. 3 illustrates an example of a 3D chiplet-based accelerator.

FIG. 4 illustrates an example of a core chiplet.

FIG. 5 illustrates an example of a parallel processing function of a core chiplet.

FIGS. 6A and 6B illustrate examples of a number-theoretic transform (NTT) operation method.

FIG. 7 illustrates an example of an NTT operation method.

FIG. 8 illustrates an example of an operation of a first NTT architecture.

FIG. 9 illustrates an example of an operation of a second NTT architecture.

FIG. 10 illustrates an example of a data exchange method among chiplets.

FIGS. 11A to 11C illustrate examples of a chiplet architecture.

Throughout the drawings and the detailed description, unless otherwise described or provided, it may be understood that the same drawing reference numerals refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated.

Unless otherwise defined, all terms including technical and scientific terms used herein have the same meaning as commonly understood by one of ordinary skill in the art to which the present disclosure pertains and based on an understanding of the disclosure of the present application. It will be further understood that terms, such as those defined in commonly-used dictionaries, should be interpreted as having a meaning that is consistent with their meaning in the context of the relevant art and the disclosure of the present application, and will not be interpreted in an idealized or overly formal sense unless expressly so defined herein.

When describing the examples with reference to the accompanying drawings, like reference numerals refer to like components and a repeated description related thereto will be omitted. In the description of examples, detailed description of well-known related structures or functions will be omitted when it is deemed that such description will cause ambiguous interpretation of the present disclosure.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

The same name may be used to describe an element included in the examples described above and an element having a common function. Unless stated otherwise, the description of an example may be applicable to other examples, and a repeated description related thereto is omitted.

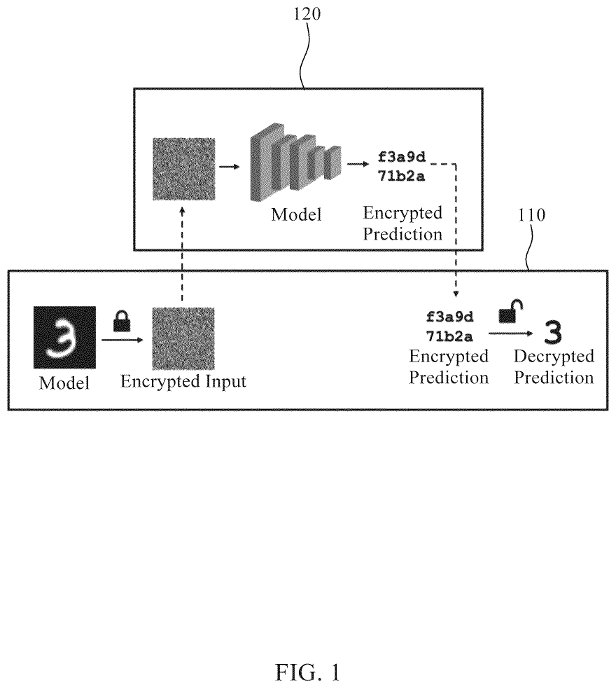

FIG. 1 illustrates an example of a homomorphic encryption (HE) system.

Referring to FIG. 1, the HE system may include a client 110 and a server 120 as agents.

The HE system may be a system in which the server 120 provides an artificial intelligence service to the client 110 without data of the client 110 being directly exposed to the server 120.

The client 110 may be an agent receiving the artificial intelligence service from the server 120 and may be referred to as a service using entity, a service user, a data user, and the like. The client 110 may encrypt its own data (e.g., an image) through a client terminal based on an HE technique and transmit the encrypted data to the server 120. The client terminal may be referred to as a user terminal.

HE is an encryption technique for performing an operation on encrypted data without decryption. When various operations are performed on homomorphically encrypted data, the results are identical to those of the same operations performed on unencrypted data. HE may process data while the data is encrypted, offering a solution to privacy concerns in the data industry.

The server 120 may receive the encrypted data from the client 110 and transmit an artificial intelligence operation result corresponding to the encrypted data to the client 110. The server 120 may be referred to as a service provider, a service providing entity, and the like.

The server 120 may provide various artificial intelligence services to the client 110. For example, the server 120 may provide the client 110 with a service such as face recognition and/or mask detection, where maintaining the confidentiality of user data is crucial. However, an operation for providing an artificial intelligence service may use a large amount of memory and extensive network data transmission. For example, when encrypting data for convolutional neural network inference, numerous homomorphic ciphertexts may be generated, demanding a large amount of memory and extensive network data transmission.

An HE operation may support an addition operation, a multiplication operation, and a rotation operation, which rearranges the order within the same encryption, and the execution time may increase in the order of addition, multiplication, and rotation.

HE may have a predetermined degree of a polynomial as a parameter. This degree may be a power of 2. As the degree of a polynomial increases, the execution time of all operations exponentially increases. However, a higher degree of a polynomial enables a wider variety of operations and improves the accuracy of operations.

The HE operation may allow a predetermined maximum number of HE multiplications. As this maximum number of multiplications increases, the time required for a single HE operation increases exponentially. Furthermore, this maximum number of multiplications is limited by the degree of a polynomial. As the degree increases, the maximum number of multiplications also increases.

The HE operation may require 1000 times more performance and memory capacity than plaintext in terms of complexity and memory usage. Accordingly, when the HE operation is performed on a central processing unit (CPU), the execution time of the operation may be so slow that the operation may not be used in an actual application. Thus, a technique for accelerating an HE operation using a graphics processing unit (GPU), a field-programmable gate array (FPGA), and the like is proposed.

A monolithic accelerator architecture for a lattice-based HE operation may be significantly expensive and may require complex manufacturing processes. In addition, a large monolithic architecture may face a persistent issue of low yield. As an alternative, a multi-chiplet architecture according to one or more embodiments may be used to accelerate an HE operation. By using a multi-chiplet design instead of one large chip, the multi-chiplet architecture according to one or more embodiments may reduce manufacturing costs and increase yields. Furthermore, when the multi-chiplet architecture according to one or more embodiments is used, multiple configurations are possible, providing flexibility to a single tape-out.

A chiplet architecture may include processing elements (PEs) and a memory. The PEs may communicate with one another and may communicate with an external memory (e.g., high bandwidth memory (HBM)). Hereinafter, a scalable design methodology of one or more embodiments that may be utilized to provide exceptional acceleration with a chiplet-based accelerator is described.

“Chiplet” may refer to breaking apart a chip into two or more parts instead of integrating components into a single die. A chiplet system may offer efficiency due to less expensive manufacturing requirements and high yield and may provide flexibility with various configurations through a single tape-out.

Chiplet packaging may be classified into three broad categories of 2 dimensional (2D) packaging, 2.5D packaging, and 3D packaging. In 2D packaging, various dies, known as multi-chip modules (MCMs), are mounted on a substrate. 2D packaging is named as such because all dies are placed on the same plane. Due to substrate limitations, 2D packaging may lead to slow communication between dies and high power consumption.

In 2.5D packaging, an interposer is disposed between a die and a substrate, and a die-to-die connection may be established via the interposer. For example, the interposer includes a silicon interposer. The high interconnectivity provided by the interposer may improve performance. 3D packaging refers to stacking different dies, similar to how skyscrapers are constructed, taking packaging to the next level of advancement. Dies in 3D packaging may be connected to one another through a through-silicon via (TSV). As an example, there is HBM, which includes multiple stacked HBM dynamic random access memory (DRAM) dies. 3D packaging may shorten a critical path, providing significantly higher performance, lower power consumption, and higher bandwidth than 2.5D packaging

Another advantage of the multi-chiplet architecture according to one or more embodiments is the potential for heterogeneous packaging. This allows an existing chiplet to be reused and various chiplets to be integrated depending on their functions. However, chiplet placement is a lengthy and intricate process. Incorrect placement may lead to potential deadlock issues in chiplet-to-chiplet communication, even if such issues do not exist at the design level.

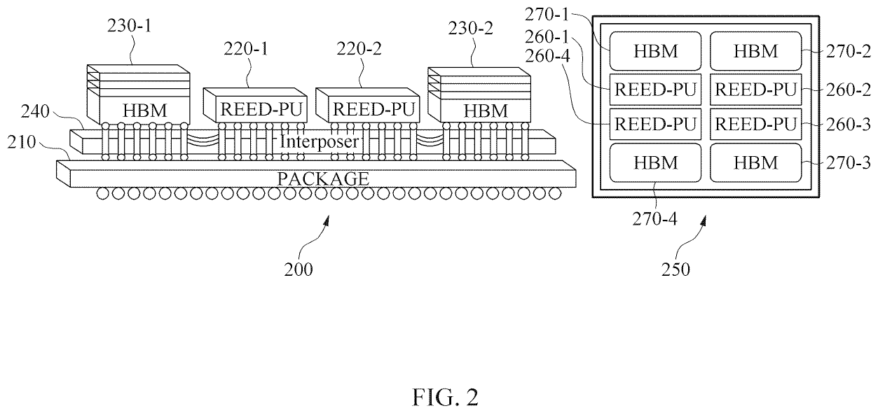

FIG. 2 illustrates an example of a 2.5D chiplet-based accelerator.

FIG. 2 illustrates a front view of a 2.5D chiplet-based accelerator 200 and a plan view of a 2.5D chiplet-based accelerator 250. The 2.5D chiplet-based accelerator 200 may connect two PEs (e.g., a first core chiplet 220-1 and a second core chiplet 220-2) together and may connect two memories (e.g., a first memory chiplet 230-1 and a second memory chiplet 230-2) together through an interposer 240. However, the internal structure of the 2.5D chiplet-based accelerator 200 is not limited to the illustration shown in FIG. 2. It is to be understood by one of ordinary skill in the art to which the disclosure pertains that some of the components shown in FIG. 2 may be omitted or new components may be added according to the design of the 2.5D chiplet-based accelerator 200.

Neighboring core chiplets may be connected to each other through the interposer 240. The interposer 240 may be attached to the top of a substrate 210 and may include a plurality of TSVs.

A core chiplet may be referred to as a PE, a processing unit (PU), and/or REED. Furthermore, a memory of the 2.5D chiplet-based accelerator 200 may also be implemented in the form of a chiplet. In this case, a memory chiplet may include an HBM chiplet. The memory chiplet may be referred to as an external memory to distinguish the memory chiplet from a register in a core chiplet.

It may be difficult for chiplet packaging to have a complex connection due to the nature of an interposer. Therefore, in the multi-chiplet architecture according to one or more embodiments, PEs may not share memory chiplets, and a connection between PEs may be simple. For example, the first core chiplet 220-1 and the second core chiplet 220-2 may not share memory chiplets. In other words, the first memory chiplet 230-1 may be connected to the first core chiplet 220-1 but not to the second core chiplet 220-2. Similarly, the second memory chiplet 230-2 may be connected to the second core chiplet 220-2 but not to the first core chiplet 220-1.

Furthermore, a 2.5D chiplet-based accelerator 250 may connect four PEs (e.g., a first core chiplet 260-1, a second core chiplet 260-3, a third core chiplet 260-3, and a fourth core chiplet 260-4) together and connect four memories (e.g., a first memory chiplet 270-1, a second memory chiplet 270-2, a third memory chiplet 270-3, and a fourth memory chiplet 270-4) together through an interposer.

In this case, the first core chiplet 260-1 to the fourth core chiplet 260-4 may be in a ring structure, and thus, neighboring core chiplets may be connected to each other through the interposer 240. The first core chiplet 260-1, the second core chiplet 260-2, the third core chiplet 260-3, and the fourth core chiplet 260-4 may be connected to one another in the listed order in a ring structure. In other words, the connection between the first core chiplet 260-1 and the third core chiplet 260-3 may be established only through the second core chiplet 260-2, and a direct connection between the first core chiplet 260-1 and the third core chiplet 260-3 may not be established. The same may also apply between the second core chiplet 260-2 and the fourth core chiplet 260-4.

Likewise, in the 2.5D chiplet-based accelerator 250, the first core chiplet 260-1 to the fourth core chiplet 260-4 may not share memory chiplets. For example, the first memory chiplet 270-1 may be connected to the first core chiplet 260-1 but not to the other core chiplets (260-2, 260-3, and 260-4). The second memory chiplet 270-2 may be connected to the second core chiplet 260-2 but not to the other core chiplets (260-1, 260-3, and 260-4). The third memory chiplet 270-3 may be connected to the third core chiplet 260-3 but not to the other core chiplets (260-1, 260-2, and 260-4). The fourth memory chiplet 270-4 may be connected to the fourth core chiplet 260-4 but not to the other core chiplets (260-1, 260-2, and 260-3). A technique for designing a 2.5D chiplet-based accelerator is not limited to the technique described above. Depending on the design, the number of core chiplets and memory chiplets may vary.

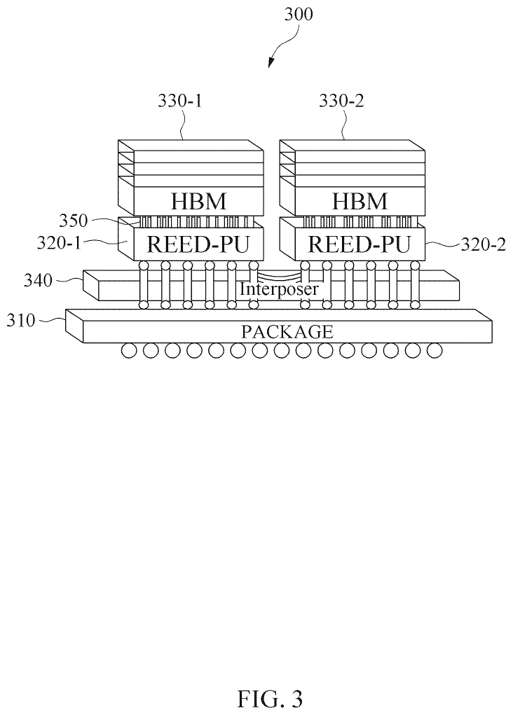

FIG. 3 illustrates an example of a 3D chiplet-based accelerator.

Referring to FIG. 3. a 3D chiplet-based accelerator 300 may connect two PEs (e.g., a first core chiplet 320-1 and a second core chiplet 320-2) together through an interposer 340 and connect two memories (e.g., a first memory chiplet 330-1 and a second memory chiplet 330-2) to the top of the PEs (e.g., the first core chiplet 320-1 and the second core chiplet 320-2) through a TSV 350. However, the internal structure of the 3D chiplet-based accelerator 300 is not limited to the illustration shown in FIG. 3. It is to be understood by one of ordinary skill in the art to which the disclosure pertains that some of the components shown in FIG. 3 may be omitted or new components may be added according to the design of the 3D chiplet-based accelerator 300.

Neighboring core chiplets (e.g., the first core chiplet 320-1 and the second core chiplet 320-2) may be connected to each other through the interposer 340. The interposer 340 may be attached to the top of a substrate 310 and may include a plurality of TSVs.

Two memories (e.g., the first memory chiplet 330-1 and the second memory chiplet 330-2) may be stacked on the PEs (e.g., the first core chiplet 320-1 and the second core chiplet 320-2). For example, the first memory chiplet 330-1 may be stacked on the first core chiplet 320-1 through the TSV 350 and the second memory chiplet 330-2 may be stacked on the second core chiplet 320-2 through the TSV 350. Accordingly, the PEs (e.g., the first core chiplet 320-1 and the second core chiplet 320-2) may not share memories (e.g., the first memory chiplet 330-1 and the second memory chiplet 330-2).

When packing the same number of chiplets when constructing a chiplet-based accelerator, using 3D packaging may reduce a chip surface area compared to 2.5D packaging. Therefore, with 3D packaging, a much smaller interposer and substrate may also be used. A technique for designing a 3D chiplet-based accelerator is not limited to the technique described above. Depending on the design, the number of core chiplets and memory chiplets may vary.

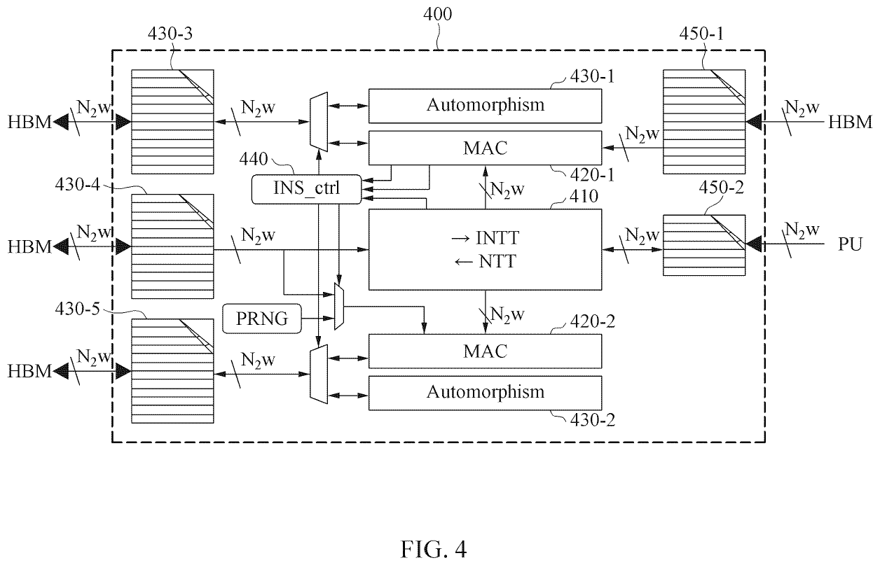

FIG. 4 illustrates an example of a core chiplet. The description provided with reference to FIGS. 1 to 3 may also apply to FIG. 4.

Referring to FIG. 4, a core chiplet 400 may correspond to an accelerator. As described above, an accelerator may be an accelerator for an HE operation. A hardware architecture may be configured based on the N=N1*N2 parameter (where N, N1, and N2 are powers of 2, and N is the size of a polynomial). In an architecture with the N₁*N₂ configuration, individual arithmetic modules may use a memory bandwidth of N₂ coefficients per cycle and may provide f/N1 operational throughput per second (where f denotes a design operating frequency).

Since memory bandwidth is a major bottleneck in an HE operation, a design according to one or more embodiments may readily scale within this constraint, providing optimal throughput. The proposed method of one or more embodiments offers easy configuration of N1 and N2 values based on available resources and throughput requirements and also facilitates prototyping and verification. Since all configurations follow the same design and implementation strategy, verifying the functionality of a smaller configuration may also provide proof of work for a much larger configuration. Thus, formal verification of the entire design may be simpler.

An HE operation may include basic operations such as an addition operation, a multiplication operation, and a rotation operation. Most applications, such as machine learning and statistics, may be evaluated using these basic operations. In HE, noise may be randomly added to a ciphertext for security purposes. The noise increases as more operations are performed. A bootstrapping operation may be used to reduce the noise. The bootstrapping operation makes a schema “fully HE (FHE)”. A method according to one or more embodiments may include all components for using an FHE system.

A core chiplet 400 may be a basic component for processing HE using a residue number system (RNS). The core chiplet 400 may be configured with the best routing and placement strategy in mind. In particular, since a relinearization operation may be the most expensive operation, the core chiplet 400 may be tailored to ensure high throughput.

In response to multiplication, a nonlinear ciphertext component may include L polynomials (1 for each qᵢ RNS base, i≤L). For relinearization, all L residue polynomials may be converted from slots into coefficient representations (using an inverse number theoretic transform (INTT)), each polynomial may be converted into (L+K) number theoretic transform (NTT), and then two key components may be multiplied and accumulated. K may denote the number of pi RNS bases used for key switching. This part may implement multiplication and accumulation of L INTTs, L*(L+K) NTT, and 2L*(L+K). This operational throughput may be reduced through an f/(L*(1+3(L+K))*N1) operation.

The core chiplet 400 may include an NTT module 410. The core chiplet 400 may further include a first multiply-accumulate (MAC) module 420-1, a second MAC module 420-2, a first automorphism module 430-1, a second automorphism module 430-2, a controller 440 (e.g., one or more processors), a first register 450-1, a second register 450-2, a third register 450-3, a fourth register 450-4, and a fifth register 450-5. The term “module” used herein may be a component including one or a combination of two or more of hardware, software, and firmware. The term “module” may be used interchangeably with other terms, for example, “logic”, “logical block”, “component”, or “circuit”. The “module” may be a minimum component of an integrally formed component or part thereof. The “module” may be a minimum component for performing one or more functions or part thereof. The “module” may be implemented mechanically or electronically. For example, the “module” may include any one or any combination of any two or more of an application-specific integrated circuit (ASIC) chip, FPGAs, and/or a programmable-logic device that performs known operations or operations to be developed.

The NTT module 410 may perform an NTT operation and an INTT operation. The NTT module 410 may be referred to as an NTT/INTT module. The NTT module 410 may work with one polynomial at a time, but the results may be accumulated by multiplying two polynomials (e.g., key switching keys). Thus, the core chiplet 400 may maintain the throughput of the NTT module 410 by instantiating a pair of MAC modules (e.g., the first MAC module 420-1 and the second MAC module 420-2) and simultaneously processing two key components.

Similarly, the core chiplet 400 may include two automorphism modules (e.g., the first automorphism module 430-1 and the second automorphism module 430-2). The first automorphism module 430-1 and the second automorphism module 430-2 may not need to operate simultaneously. Thus, the core chiplet 400 may use the same memory to supply data to both of the two automorphism modules.

The core chiplet 400 may use a pseudo random number generator (PRNG) to generate a first key component. A second component may be stored in the first register 450-1 and may only be supplied to the first MAC module 420-1. When performing a dyadic operation, the first MAC module 420-1 may receive two inputs from the first register 450-1 and the third register 450-3. However, in order to provide the same function to the second MAC module 420-2, a memory for an NTT/INTT module may be connected to the second MAC module 420-2.

This configuration is an instruction-based configuration, in which the controller 440 may manage multiplexers and collect a signal completed from one of the NTT module 410, MAC modules, and/or automorphism modules. This design choice may ensure that the NTT module 410, MAC modules, and automorphism modules are executed in parallel in a pipeline.

The first register 450-1, the third register 450-3, the fourth register 450-4, and the fifth register 450-5 included in the core chiplet 400 may communicate with an off-chip memory. The second register 450-2 may communicate with another core chiplet 400. The second register 450-2 may perform a role of storing an INTT result and transferring the INTT result to another PU.

Of the four memories (e.g., the first register 450-1, the third register 450-3, the fourth register 450-4, and the fifth register 450-5) that communicate with the off-chip memory, there may be two memories (e.g., the third register 450-3 and the fifth register 450-5) that may rewrite a result.

In other words, there are three memories that implement reading/writing for on-chip and off-chip communication. The second register 450-2 may be used for an on-chip operation, and the third register 450-3 and the fifth register 450-5 may perform prefetching with the off-chip memory. Therefore, these three memories may use at least two polynomial storages, while the other two may only use at least one polynomial storage. These memories may be readily placed at locations away from a building block and the vicinity of a chip to avoid congestion. Then, a register file may be used to connect these memories to the building block. Accordingly, the core chiplet 400 of one or more embodiments may have a highly simplified and high-throughput configuration.

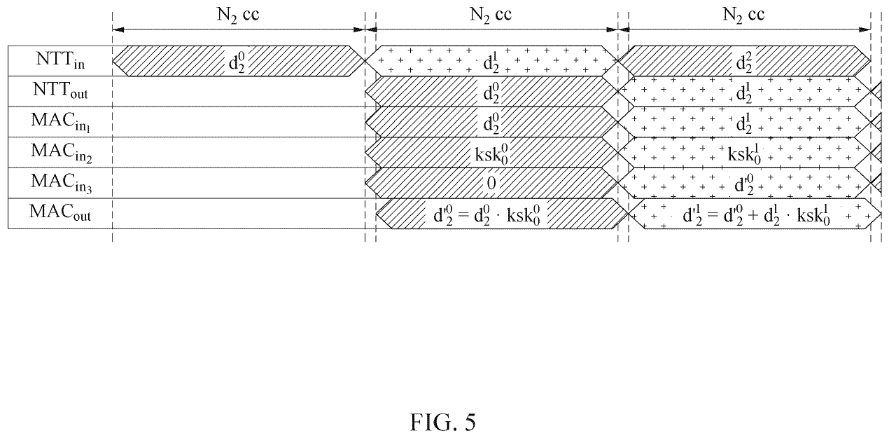

FIG. 5 illustrates an example of a parallel processing function of a core chiplet.

Referring to FIG. 5, the core chiplet 400 may simultaneously perform multiplication and accumulation operations. As described above, since the controller 440 may manage multiplexers and collect a signal completed from one of the NTT module 410, MAC modules, and automorphism modules, the core chiplet 400 may simultaneously perform multiplication and accumulation operations. Thus, the core chiplet 400 of one or more embodiments may save 2L(L+1) clock cycles through a parallel operation and may improve throughput to

$$\frac{{f}^{‵}}{L ( L + 3 ) \cdot {N}_{1}} ;$$

resulting in a 66.7% increase in throughput.

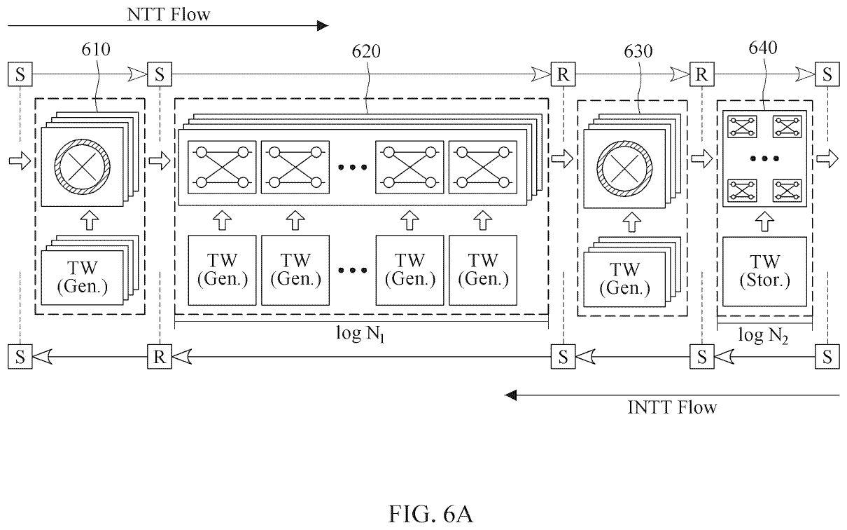

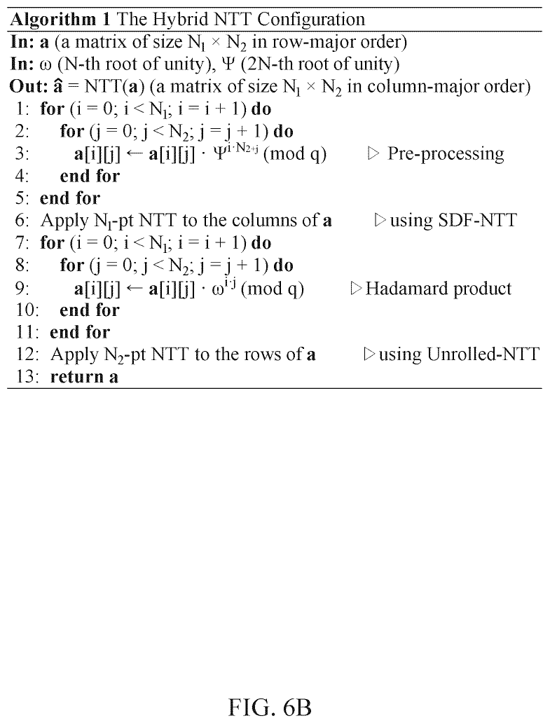

FIGS. 6A and 6B illustrate examples of an NTT operation method.

Referring to FIG. 6A, an NTT module (e.g., the NTT module 410 of FIG. 4) may include a preprocessing module 610, a first NTT architecture 620, a Hadamard module 630, and a second NTT architecture 640.

The NTT module may perform an NTT operation and an INTT operation. The NTT module may perform the NTT operation by sequentially inputting an input polynomial for the NTT operation into the preprocessing module 610, the first NTT architecture 620, the Hadamard module 630, and the second NTT architecture 640. The NTT module may perform the INTT operation by sequentially inputting an input polynomial for the INTT operation into the second NTT architecture 640, the Hadamard module 630, the first NTT architecture 620, and the preprocessing module 610.

Referring to FIG. 6B, the input polynomial for the NTT operation may be stored in the N₂ memory with a depth of N₁. Thus, an input matrix of size N₁×N₂=N may be formed in row order. In other words, the input matrix may include coefficients of an input polynomial.

The preprocessing module 610 may perform a preprocessing operation on the coefficients. The preprocessing module 610 may perform a preprocessing operation and may perform an operation of multiplying a coefficient by a 2N-th root of unity. The preprocessing module 610 may perform a preprocessing operation such as Equation 1 below, for example.

$$a [ i ] [ j ] ← a [ i ] [ j ] \cdot {ψ}^{i \cdot {N}_{2} + j} ( mod q ) \qquad Equation 1$$

The preprocessing module 610 may be N₂-type modular multipliers.

The first NTT architecture 620 may perform a first NTT operation on a column element of an input matrix for which the preprocessing operation is completed. Performing the first NTT operation on the column element may be referred to as an N₁-point NTT operation. The first NTT architecture 620 may be referred to as a single delayed feedback (SDF)-NTT architecture.

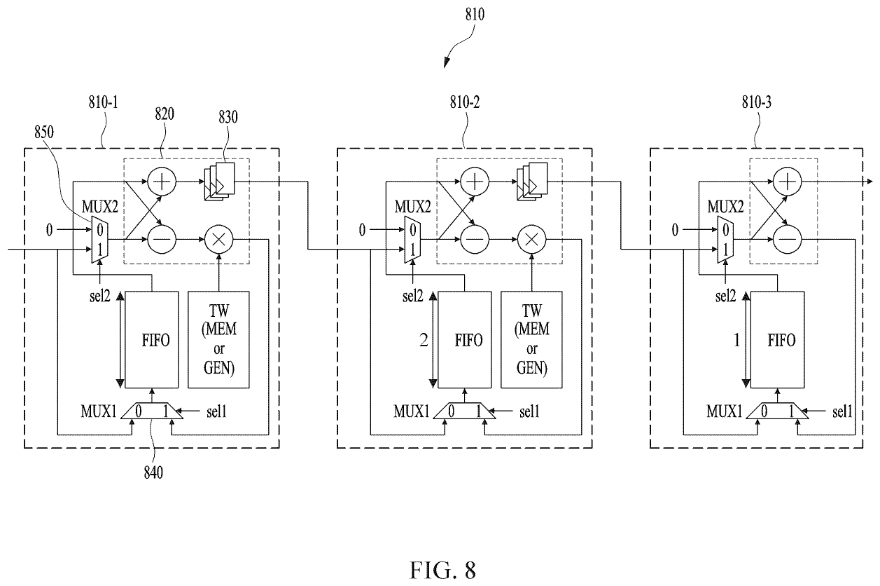

The first NTT architecture 620 may be pipelined and may read an N2 coefficient from a memory in each cycle. The first NTT architecture 620 may include first NTT modules corresponding to a stage included in the first NTT operation. The first NTT units included in the first NTT architecture 620 may perform operations independently of each other. An example of an operating method of the first NTT architecture 620 is described in detail below with reference to FIG. 8.

The Hadamard module 630 may perform a Hadamard product operation between a first NTT operation result and a twiddle factor. The Hadamard module 630 may be an N2-type modular multiplier.

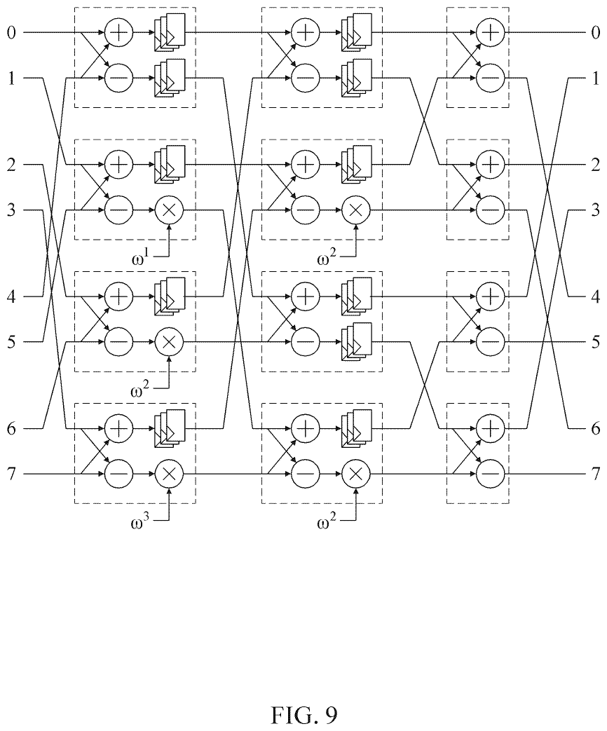

The second NTT architecture 640 may perform a second NTT operation on a row element of an input matrix for which the Hadamard product operation is completed. Performing the second NTT operation on the row element may be referred to as an N₂-point NTT operation. The second NTT architecture 640 may be referred to as an unrolled-NTT. An example of an operating method of the second NTT architecture 640 is described in detail below with reference to FIG. 9.

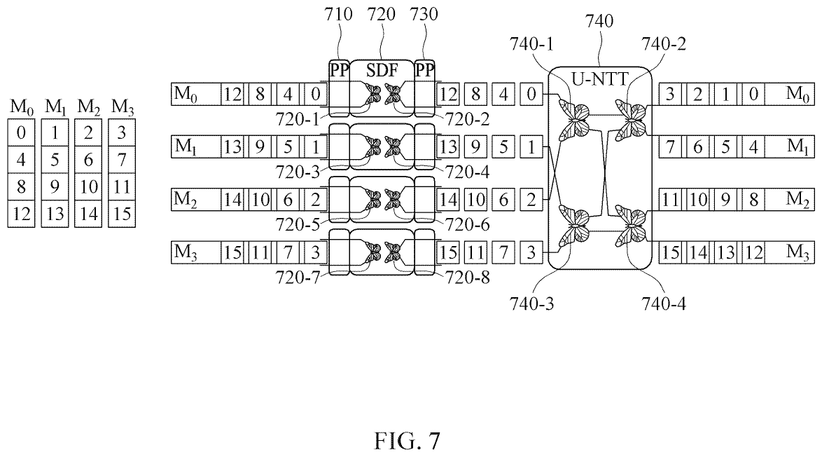

FIG. 7 illustrates an example of an NTT operation method.

Referring to FIG. 7, an input polynomial for an NTT operation may form an input matrix with a size of 4×4=16. A preprocessing module 710 may perform a preprocessing operation on column elements (e.g., M₀, M₁, M₂, and M₃) of the input matrix. The preprocessing module 710 may perform a preprocessing operation on each of the column elements (e.g., M₀, M₁, M₂, and M₃) of the input matrix simultaneously and in parallel. In FIG. 7, the numbers of matrix elements may represent the coefficient indices of a polynomial.

A first NTT architecture 720 may include first NTT operators that perform an NTT operation on each of the column elements (e.g., M₀, M₁, M₂, and M₃) of the input matrix. For example, first NTT operators 720-1 and 720-2 may perform an NTT operation on the M₀ column element, first NTT operators 720-3 and 720-4 may perform an NTT operation on the M₁ column element, first NTT operators 720-5 and 720-6 may perform an NTT operation on the M₂ column element, and first NTT operators 720-7 and 720-8 may perform an NTT operation on the M₃ column element.

Alternatively, the first NTT architecture 720 may include only one set of first NTT operators. For example, the first NTT operators 720-1 and 720-2 may perform the NTT operation on the M₀ column element in a first cycle, perform the NTT operation on the M₁ column element in a second cycle, perform the NTT operation on the M₂ column element in a third cycle, and perform the NTT operation on the M₃ column element in a fourth cycle.

The number of first NTT operators included in the first NTT architecture 720 may be determined based on stages included in a first NTT operation. Referring to FIG. 7, since there are four coefficients of a column element of an input matrix, the first NTT operation may include two stages. Therefore, the first NTT operators of the first NTT architecture 720 may be two (e.g., the first NTT operators 720-1 and 720-2). In this case, the first NTT units (e.g., the first NTT operators 720-1 and 720-2) included in the first NTT architecture 720 may perform operations independently of each other. In other words, while the first NTT operator 720-2 performs an operation, the first NTT operator 720-1 may also perform an operation. That is, continuous operations may be performed on real-time data input. While an operation is being performed on a previous input in the second half of a stage, it may be possible to simultaneously perform an operation on a new input in the first half of the stage.

The Hadamard module 730 may perform a Hadamard product operation between a first NTT operation result and a twiddle factor.

The second NTT architecture 740 may perform a second NTT operation on a row element of an input matrix for which the Hadamard product operation is completed. For example, a second NTT operation may be performed on first row elements (0, 1, 2, and 3) in the first cycle, the second NTT operation may be performed on second row elements (4, 5, 6, and 7) in the second cycle, the second NTT operation may be performed on third row elements (8, 9, 10, and 11) in the third cycle, and the second NTT operation may be performed on fourth row elements (12, 13, 14, and 15) in the fourth cycle.

The second NTT architecture 740 may include second NTT modules. The number of stages used for performing an NTT operation on N pieces of data may be n=log₂ N. The number of second NTT modules used for each stage may be N/2. Accordingly, the second NTT operation may include two stages, and the number of second NTT modules used for each stage may be two. Accordingly, the second NTT architecture 740 may include two second NTT modules 740-1 and 740-2 used for a first stage operation and two second NTT modules 740-3 and 740-4 used for a second stage operation.

An output of the first NTT architecture 720 may be directly supplied to the second NTT architecture 740. Thus, a transpose operation between the first NTT architecture 720 and the second NTT architecture 740 may not be required.

FIG. 8 illustrates an example of an operation of a first NTT architecture.

Referring to FIG. 8, a first NTT architecture 810 may include a plurality of first NTT modules (e.g., a first NTT module 810-1, a second NTT module 810-2, and a third NTT module 810-3).

As described above, the first NTT architecture 810 may include the first NTT modules (e.g., 810-1 to 810-3) respectively corresponding to stages of a first NTT operation. For example, when an NTT operation is performed on 8 pieces of data, the number of stages may be 3(log₂ 8). The first NTT module 810-1 may correspond to a first stage, the second NTT module 810-2 may correspond to a second stage, and the third NTT module 810-3 may correspond to a third stage. The first NTT modules (e.g., 810-1 to 810-3) may perform operations independently of each other.

The first NTT module 810-1 may include a butterfly operator unit (BU), a register, a first multiplexer, and a second multiplexer. For example, the first NTT module 810-1 may include a BU 820, a register 830, a first multiplexer 840, and a second multiplexer 850.

In the first NTT module 810-1, a butterfly operation may use two coefficients, and the indices of the coefficients may be distinguished by an offset depending on the NTT stage. For example, at a first NTT stage of an 8-point NTT for polynomial A, coefficient indices may be distinguished by an offset of 4 (i.e., for i=0, 1, 2, and 3, the coefficient indices are distinguished as A[i] and A[i+4]). At a second NTT stage, the coefficients may be grouped into upper and lower parts (i.e., A[0], A[1], A[2], A[3] and A[4], A[5], A[6], A[7] parts), and the indices of each part may be distinguished by an offset of 2 (i.e., for i=0, 1 and i=4, 5, A[i] and A[i+2]). At a third stage, the coefficients may be distinguished by an offset of 1.

To provide an input with an appropriate offset and order to a butterfly module, the first NTT module 810-1 may couple each butterfly module with a memory (e.g., a first-in-first-out (FIFO) memory) and a multiplexer.

When it is assumed that an 8-point NTT operation is performed, the first stage may be coupled with a memory of depth 4 because the coefficient indices of the butterfly operation are distinguished by an offset of 4. At the first stage, the first NTT module 810-1 may fetch and store the first four input coefficients in a memory one by one in the first four cycles. Here, during the first four cycles, the first multiplexer 840 may select an input coming from the left based on a control signal (sel1=0).

Then, at the first stage, the remaining four input coefficients may be fetched one by one and sent to the BU 820, and the first four coefficients may be read one by one from their own FIFO memory and sent to the BU 820.

In this way, the BU 820 may receive coefficient pairs in the correct order during the four cycles. In other words, the BU 820 may receive A[0] of FIFO and A[4] of an input in the first cycle, receive A[1] and A[5] in the second cycle, receive A[2] and A[6] in the third cycle, and receive A[3] and A[7] in the fourth cycle. During the four cycles, the second multiplexer 850 may select a non-zero input based on a control signal (sel2=1).

At the first stage, a first output (e.g., A[0] to A[3]) of the BU 820 may be transmitted to the next stage, and a second output (e.g., A[4] to A[7]) may be stored in the FIFO for later transmission to the next stage. In this case, the first multiplexer 840 may select the input from the output of the BU 820 based on a control signal (sel1=1).

Finally, the first NTT module 810-1 may be used to transmit coefficients (e.g., A[4] to A[7]) stored in the FIFO again to the first NTT module 810-2 corresponding to the next stage. To this end, the coefficients may be read from the FIFO and transmitted to the BU 820, and the second multiplexer 850 may select 0 based on a control signal (sel2=0). Since the second input of the BU 820 is 0, the first input may be directly transmitted to the output and then transmitted to the first NTT module 810-2 corresponding to the next stage (i.e., A[4]+0=A[4]).

The register 830 may be used to synchronize the output of the BU 820. The BU 820 may receive three inputs a, b, and w and perform the operations of a+b and (a−b)*w. A multiplication operation is added to the (a−b)*w operation, so the (a−b)*w operation may take longer than the a+b operation. Accordingly, the first NTT module 810-1 may include the register 830 capable of storing the a+b operation so that both outputs may be output from the BU 820 at the same time. Because the multiplication operation may take several cycles, a plurality (e.g., three) of registers 830 may be provided.

FIG. 9 illustrates an example of an operation of a second NTT architecture.

As described above, an N-point NTT operation may include log₂ N stages, where an N/2 butterfly operation is performed at each of the stages. Therefore, an N-point NTT may use a total of log₂ N*(N/2) butterfly operations.

The second NTT architecture may instantiate every stage and all BUs at every stage. The second NTT architecture may use a total of log₂ N*(N/2) BUs and connect these BUs to one another to implement the N-point NTT. The second NTT architecture may take all input coefficients (i.e., N coefficients) in one cycle and generate all output coefficients in one cycle.

Referring to FIG. 9, a second NTT architecture for N=8 is shown as an example. ω may denote a twiddle factor (an 8th identity root) of an 8-point NTT. The second NTT architecture may include 12 second NTT modules. A second NTT module may include a register placed after addition and subtraction operations. The register may be placed to synchronize an output of a BU. In FIG. 9, the numbers of inputs and outputs may respectively denote the coefficient indices of input and output polynomials.

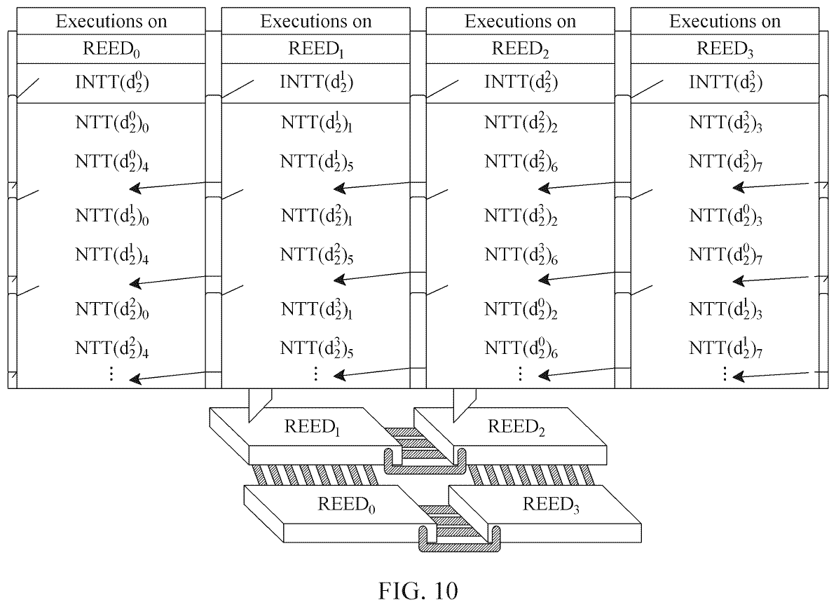

FIG. 10 illustrates an example of a data exchange method among chiplets.

A good multi-chiplet design may ensure that various chiplets operate on unique data with as much independence as possible, minimizing dependency. This is because data duplication is reduced and a shared memory is not required.

In a data distribution method, data (e.g., a key and a ciphertext) may be distributed across an RNS base. It may be most important to note that this RNS base of data is not allowed to be grouped in order (chipletᵢηᵢ₊ⱼ∀0Âi<r and 0≤j<(L+K)/r) but rather has to be interleaved (chipletᵢ ηⱼ₊ᵢ). This is because when a multiplicative depth starts to decrease, a qi RNS base is also removed sequentially. When sequences are not alternated, a core chiplet may quickly become idle, losing the benefits of parallel processing. Interleaving data distribution may ensure that all chiplets are fully utilized eventually. Therefore, these chiplets may not require data duplication and may be executed in parallel.

No matter how data is distributed, chiplet-to-chiplet communication may always be necessary. Distribution between RNS bases may alleviate this issue but may not eliminate this issue. A data exchange method (communication method) among core chiplets according to one or more embodiments may be easily expanded to a higher configuration without causing a decrease in clock frequency due to efficient pipelining. Addressing a communication bottleneck may be particularly important as it determines how efficiently multiple chiplets may be arranged in a disaggregated state of charge (SoC) configuration.

Before proposing a solution, the reason for exchanging data between chiplets is described. Data exchange may be performed for a modulus switch operation of a relinearization operation. This implies that each chiplet may have to transmit 2(r−1)L/r residue polynomials to another chiplet. In order to exchange a large amount of data, star-like communication between chiplets may be performed so that all chiplets may communicate with all other chiplets. In star-like communication, an increase in an r value may result in complex and expensive communication.

A data exchange method according to one or more embodiments may transfer an INTT result to a chiplet so that the result is within the same chiplet. The data exchange method may use a long communication window, represented by a large blue rectangle, between multiple chiplets.

A window according to one or more embodiments may be used to describe a time slot used to transmit data from one chiplet to the next in a chiplet system. A communication window may not refer to a hardware module but rather to a predetermined time window that allows optimized data transmission. The number of communication windows may be determined by the number of RNS-limbs in an FHE system and the number of chiplets used in a system.

For example, when it is assumed that a system has four chiplets from REED₀ to REED₃, each chiplet may start with an assigned RNS-limb, compute an INTT, and then perform an NTT. A chiplet may start transmitting and receiving an INTT result while performing an NTT. For example, REED₀ may transmit an INTT result to REED₃ and receive an INTT result from REED₁. This may enable one-way ring-based communication. In the example described above, a ring may include four chiplets.

For every (L+1)/r NTT, only one INTT result needs to be broadcasted, where L+1 may be the number of RNS limbs and r may be the number of REED chiplets. For a given chiplet-to-chiplet or REEDi+1-to-REEDi communication speed, the time to transmit one INTT result to the next chiplet may be referred to as t_{comm}. The time it takes to determine (L+1)/r NTT may be referred to as t_{comp}. A window length may be min(t_{comm}, t_{comp}). Efficient computation-communication parallelization may be achieved when t_{comm}≤t_{comp}. As the number of chiplets (r) increases, the window length decreases. Therefore, in order to achieve computation-communication parallelism, the communication speed between chiplets may have to be much faster.

Therefore, when inter-chiplet communication is not as fast as on-chip communication/computation, this long communication window may ensure that a chiplet does not run out of data. In conclusion, when the communication scheme according to one or more embodiments is used, half of data may need to be transmitted and only one read/write port per chiplet may be required. In addition, by employing a communication window, it may be possible to overcome the possibility of slower chiplet-to-chiplet communication and eliminate the possibility of deadlock through non-blocking communication.

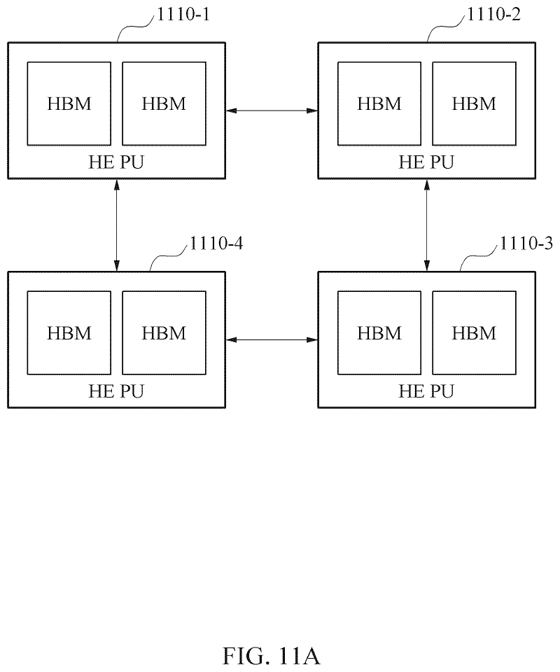

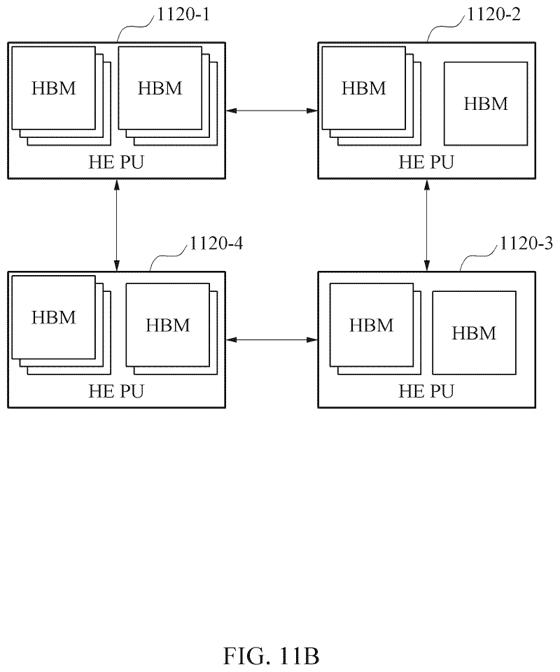

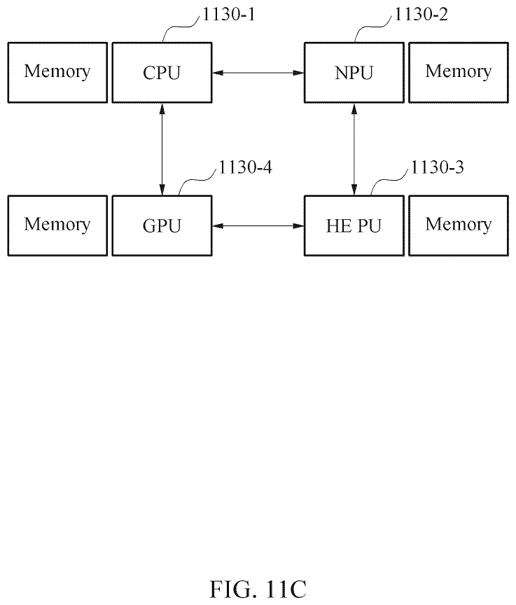

FIGS. 11A to 11C illustrate examples of a chiplet architecture.

Referring to FIG. 11A, four PUs 1110-1 to 1110-4 may be connected to one another in a ring structure. Two memories (e.g., HBM and LPDDR) may be stacked on each PU.

Referring to FIG. 11B, four PUs (e.g., a first PU 1120-1, a second PU 1120-2, a third PU 1120-3, and a fourth PU 1120-4) may be connected to one another in a ring structure. Memories of different numbers and structures may be stacked on the PUs. For example, two sets of memories may be stacked on the first PU 1120-1, and each set may include three stacked memories. Two sets of memories may be stacked on the second PU 1120-2, with the first set including three stacked memories and the second set including one memory. Two sets of memories may be stacked on the third PU 1120-3, with the first set including two stacked memories and the second set including one memory. Two sets of memories may be stacked on the fourth PU 1120-4, with the first set including three stacked memories and the second set including two memories.

Referring to FIG. 11C, heterogeneous core chiplets may be connected to one another in a ring structure. For example, a CPU 1130-1, a neural PU (NPU) 1130-2, an HE PU 1130-3, and a GPU 1130-4 may be connected to one another in a ring structure.

The clients, servers, 2.5D chiplet-based accelerators, core chiplets, memory chiplets, 3D chiplet-based accelerators, NTT modules, MAC modules, automorphism modules, controllers, registers, preprocessing modules, NTT architectures, Hadamard modules, NTT operators, BUs, registers, multiplexers, Pus, CPUs, NPUs, HE PUS, GPUs, client 110, server 120, 2.5D chiplet-based accelerator 200, 2.5D chiplet-based accelerator 250, first core chiplet 220-1, second core chiplet 220-2, first memory chiplet 230-1, second memory chiplet 230-2, first core chiplet 260-1 to fourth core chiplet 260-4, first memory chiplet 270-1, second memory chiplet 270-2, third memory chiplet 270-3, fourth memory chiplet 270-4, 3D chiplet-based accelerator 300, first core chiplet 320-1, second core chiplet 320-2, first memory chiplet 330-1, second memory chiplet 330-2, core chiplet 400, NTT module 410, first MAC module 420-1, second MAC module 420-2, first automorphism module 430-1, second automorphism module 430-2, controller 440, first register 450-1, second register 450-2, third register 450-3, fourth register 450-4, fifth register 450-5, preprocessing module 610, first NTT architecture 620, Hadamard module 630, second NTT architecture 640, preprocessing module 710, first NTT architecture 720, first NTT operators 720-1 to 720-8, Hadamard module 730, second NTT architecture 740, second NTT modules 740-1 to 740-4, first NTT architecture 810, first NTT module 810-1, second NTT module 810-2, third NTT module 810-3, BU 820, register 830, first multiplexer 840, second multiplexer 850, PUs 1110-1 to 1110-4, first PU 1120-1, second PU 1120-2, third PU 1120-3, fourth PU 1120-4, CPU 1130-1, NPU 1130-2, HE PU 1130-3, and GPU 1130-4 described herein, including descriptions with respect to respect to FIGS. 1-11C, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-11C that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device comprising:
a substrate;
an interposer attached to a top of the substrate and comprising a plurality of through-silicon vias (TSVs);
a plurality of core chiplets attached to a top of the interposer; and
a plurality of memory chiplets attached to the top of the interposer,
wherein each of the plurality of core chiplets comprises a number-theoretic transform (NTT) module.

2. The electronic device of claim 1, wherein the plurality of memory chiplets are not connected to each other.

3. The electronic device of claim 1, wherein the plurality of core chiplets are electrically connected to each other in a ring structure through the interposer.

4. The electronic device of claim 1, wherein each of the plurality of core chiplets is configured to transmit data from the NTT module of a corresponding core chiplet to a core chiplet adjacent to the corresponding core chiplet in a first direction.

5. The electronic device of claim 4, wherein
the NTT module is configured to perform a homomorphic encryption (HE) operation comprising a relinearization operation, and
the data from the NTT module comprises inverse NTT (INTT) residue polynomial data generated from the relinearization operation.

6. The electronic device of claim 1, wherein each of the plurality of core chiplets further comprises:
a pair of multiply-accumulate (MAC) modules connected to the NTT module; and
a pair of automorphism modules connected respectively to the pair of MAC modules.

7. The electronic device of claim 6, wherein each of the plurality of core chiplets further comprises a controller configured to:
obtain an operation completion signal from the NTT module, the pair of MAC modules, and the pair of automorphism modules; and
control the NTT module and the pair of MAC modules to operate in parallel.

8. The electronic device of claim 1, wherein each of the plurality of core chiplets further comprises a first memory connected to the NTT module and configured to store an inverse NTT (INTT) operation result.

9. The electronic device of claim 8, wherein each of the plurality of core chiplets is configured to transmit the INTT operation result stored in the first memory of a corresponding core chiplet to a core chiplet adjacent to the corresponding core chiplet in a first direction.

10. The electronic device of claim 1, wherein the plurality of memory chiplets comprises a high bandwidth memory (HBM) chiplet.

11. An electronic device comprising:
a substrate;
an interposer attached to a top of the substrate and comprising a plurality of through-silicon vias (TSVs);
a plurality of core chiplets attached to a top of the interposer; and
a plurality of memory chiplets vertically attached to the plurality of core chiplets through a TSV,
wherein each of the plurality of core chiplets comprises a number-theoretic transform (NTT) module.

12. The electronic device of claim 11, wherein the plurality of core chiplets is electrically connected to each other in a ring structure through the interposer.

13. The electronic device of claim 11, wherein each of the plurality of core chiplets is configured to transmit data from the NTT module of a corresponding core chiplet to a core chiplet adjacent to the corresponding core chiplet in a first direction.

14. The electronic device of claim 11, wherein each of the plurality of core chiplets further comprises:
a pair of multiply-accumulate (MAC) modules connected to the NTT module; and
a pair of automorphism modules connected respectively to the pair of MAC modules.

15. The electronic device of claim 11, wherein the plurality of memory chiplets comprises at least one of a high bandwidth memory (HBM) chiplet and a low-power double data rate (LPDDR) chiplet.

16. An electronic device comprising:
a number-theoretic transform (NTT) module;
a pair of multiply-accumulate (MAC) modules connected to the NTT module; and
a pair of automorphism modules connected respectively to the pair of MAC modules.

17. The electronic device of claim 16, further comprising a controller configured to obtain an operation completion signal from the NTT module, the pair of MAC modules, and the pair of automorphism modules and control the NTT module and the pair of MAC modules to operate in parallel.

18. An electronic device comprising:
a substrate;
an interposer attached to a top of the substrate and comprising a plurality of through-silicon vias (TSVs);
a plurality of core chiplets attached to a top of the interposer; and
a plurality of memory chiplets connected to the plurality of core chiplets through either the interposer or a TSV,
wherein each of the plurality of core chiplets comprises a number-theoretic transform (NTT) module.

19. The electronic device of claim 18, wherein the plurality of memory chiplets are attached to the top of the interposer and horizontally spaced apart from the plurality of core chiplets.

20. The electronic device of claim 18, wherein the plurality of memory chiplets are vertically attached to the plurality of core chiplets through the TSV.
